(19) United States
(12) Patent Application Publication
(10) Pub. No.: US 2008/0276511 A1
(43) Pub. Date: Nov. 13, 2008

(54) Slats For Rotary-Prism Display Panels

(75) Inventor: Gerard Large, Oyonnax (FR)

Correspondence Address: YOUNG & THOMPSON, 209 Madison Street, Suite 500, ALEXANDRIA, VA, 22314, US

(73) Assignee: MECATEC, DAGNEUX (FR)

(21) Appl. No.: 12/093,714

(22) PCT Filed: Nov. 16, 2006
(86) PCT No.: PCT/FR2006/002528

§ 371 Date: May 15, 2008

Related U.S. Application Data
(60) Provisional application No. 60/774,674, filed on Feb. 21, 2006.

(30) Foreign Application Priority Data
Nov. 18, 2005 (FR) 0511685

(51) Int. Cl. G09F 7/18

(52) U.S. Cl. 40/607.15

(57) ABSTRACT

An attachment device includes at least one slat (51, 52) which in profile is in the shape of an arc of a circle, the internal face (54) of which is secured to snap-fastening elements (55), whereas each slat (51, 52) has, at its snap-fastening element (55), an elastic-deformation height d allowing a pressure force to be exerted on the far edges (53) of each slat (51, 52) so that the continuous flaps (7) of a corresponding poster strip (5) are held between the far edges (53) and the face (40, 41, 42) of a rotary prism (4).

The present invention relates to an attachment device for holding an advertising display consisting of display strips that are designed to be placed on advertising panels comprising rotary prism display panels.

The advertising panels receiving this kind of display comprise a plurality of rotary prisms placed side by side and rotating by a fraction of a revolution about their longitudinal axis by means of a drive device described, for example, in European patent EP 05393308 belonging to the applicant.

The advertising panels of this kind usually comprise triangular-based rotary prisms that make it possible to show successively three advertising displays. The rotary prisms receive on each of their faces a display strip forming respectively a separate display that is shown when said prisms rotate.

Each rotary prism interacts with a slat attachment device making it possible to mechanically hold display strips as described in European patent EP1105859 belonging to the applicant.

The object of the attachment device according to the invention is to enhance the mechanical retention of the display strips on the rotary prisms of the advertising panels.

The attachment device according to the present invention consists of at least one slat having a profile in an arc of a circle whose inner face is fixedly attached to snap-fitting means while each slat has at its snap-fitting means an elastic deformation height d making it possible to apply at the extreme edges of each slat a pressure force making it possible to hold, between said extreme edges and the face of the rotary prism, the continuous flaps of the corresponding display strip.

The attachment device according to the present invention comprises snap-fitting means that consist of two elastic and parallel bars placed one facing the other in order to delimit a longitudinal channel, each bar comprising at its free end and outside the channel a shoulder provided with two faces that are inclined in opposite directions at an angle α lying between 60 and 105 degrees.

The attachment device according to the present invention comprises an angle α provided between the two faces which is equal to 90 degrees.

The attachment device according to the present invention comprises a shoulder whereof the base of the first inclined face of each bar is provided, before elastic deformation, to be at a distance h from the inner face of each slat.

The attachment device according to the present invention comprises snap-fitting means that interact with a groove arranged in the face of each rotary prism and comprising a bottom and parallel walls each provided, in the direction of the center of the groove, with a longitudinal rib having a beak-shaped profile.

The attachment device according to the present invention comprises a longitudinal rib which comprises a first horizontal face parallel with the bottom of the groove and a second inclined face extending the first on the side of the opening of said groove.

The attachment device according to the present invention comprises a longitudinal rib whose first horizontal face is provided to be at a distance e from the outer face of each rotary prism.

The attachment device according to the present invention comprises a distance h, before elastic deformation of the slat, that has a dimension less than e.

The attachment device according to the present invention comprises snap-fitting means of the slat that are provided in the middle of said slat and supported via its main axis XX′ that is indistinguishable from the central axis of each face of the rotary prism.

The attachment device according to the present invention comprises slats that are symmetrical.

The attachment device according to the present invention comprises snap-fitting means of each slat that are offset laterally relative to the central axis ZZ′.

The attachment device according to the present invention comprises slats whose central axis ZZ′ is offset laterally from the central axis YY′ of each face of the rotary prism.

The attachment device according to the present invention comprises slats whose extreme edge furthest from the snap-fitting means is designed to interact, after elastic deformation of the slat, with the continuous flap of the display strip.

The following description with reference to the appended drawings given as nonlimiting examples will make it possible to better understand the invention, the features that it proposes and the advantages that it is likely to procure.

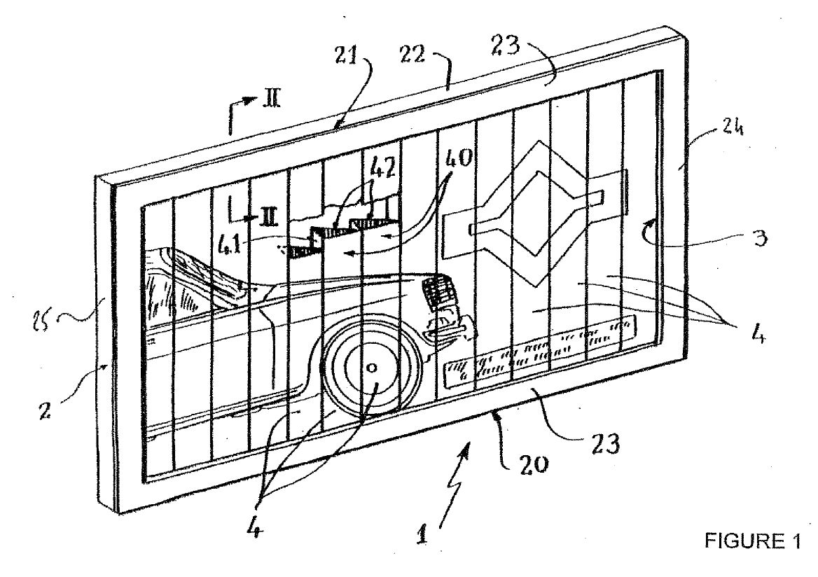

FIG. 1 is a view in perspective illustrating an advertising panel provided with movable prismatic members.

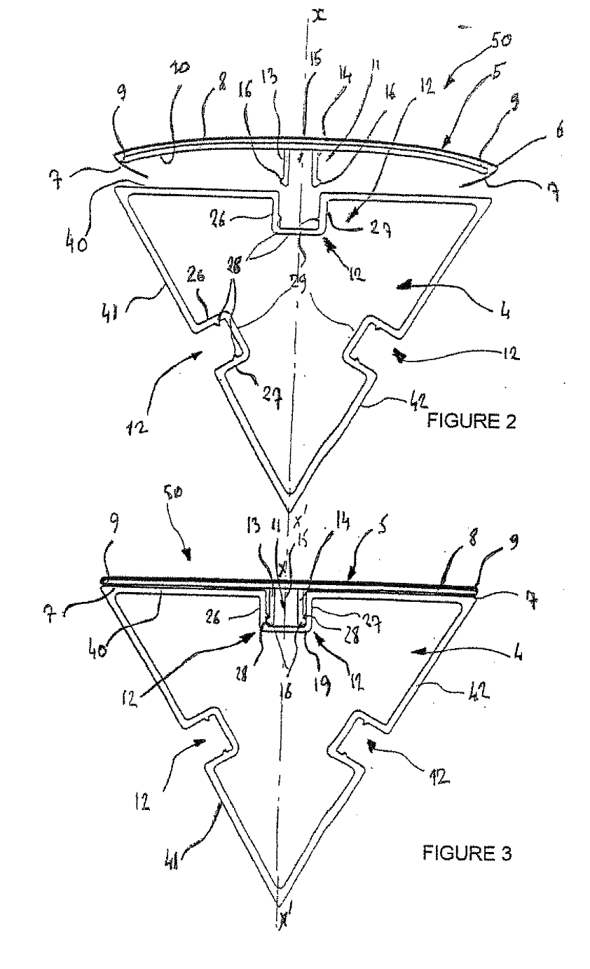

FIGS. 2 and 3 are views illustrating respectively the attachment device before and after it has been snap-fitted to the face of the corresponding rotary prism of the display panel according to the present invention.

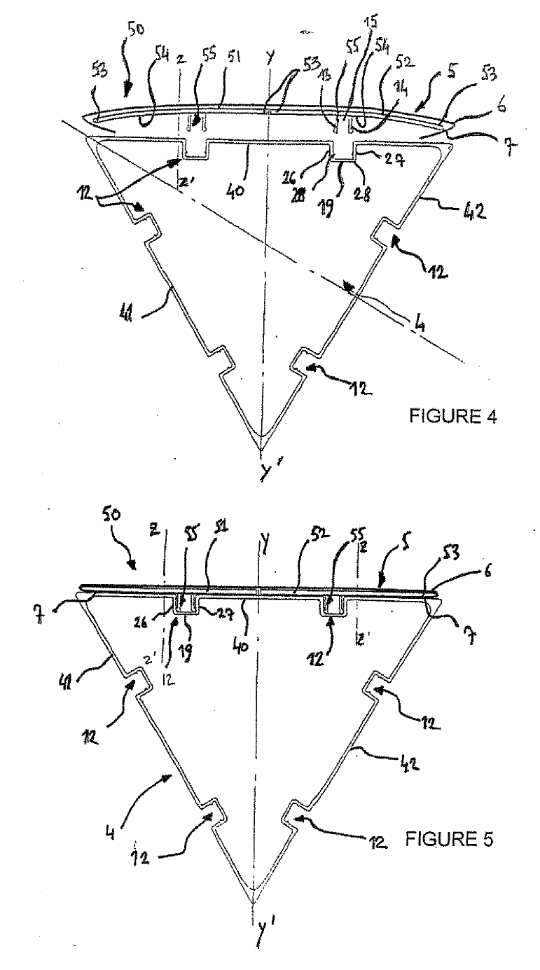

FIGS. 4 and 5 are views representing respectively a variant of the attachment device before and after it has been snap-fitted to the face of the corresponding rotary prism of the display panel according to the present invention.

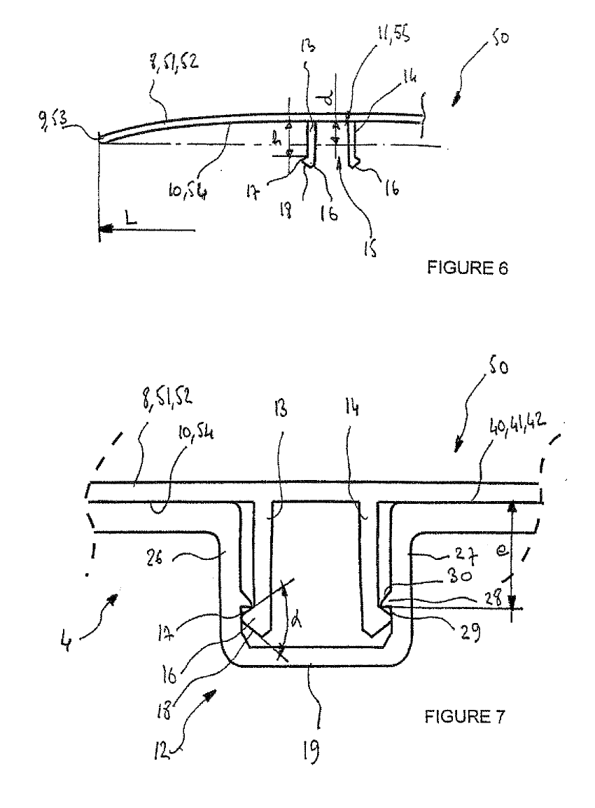

FIGS. 6 and 7 are views showing in detail the attachment device and its snap-fitting to a face of the corresponding rotary prism of the display panel according to the present invention.

FIG. 1 shows an advertising panel 1 comprising essentially a metal structure or frame 2 that comprises a rectangular opening 3 in which a series of prism-shaped movable members 4 is housed. The movable members or rotary prisms 4 are placed so that their axis of rotation is oriented either vertically or horizontally.

In the envisaged example, each movable member or rotary prism 4 is shown on a vertical axis and comprises in cross section a profile in the shape of an equilateral triangle defining three display faces 40, 41, 42.

Each of the faces comprises a portion of an image that must be shown at the same time and for a determined period to the public in order to produce, by the combination of each portion of an image, a complete advertising image.

For this, the movable members or rotary prisms 4 are side by side in order to rotate about their vertical axis so that their respective face 40, 41 and 42 is cyclically and at the same time in the same display plane in order to allow the complete display of the advertising image.

The metal frame 2 consists of horizontal cross members 20, 22 fixedly attached to vertical cross members 24, delimiting the rectangular opening 3 of the advertising panel 1.

Each cross member has a U-shaped profile whose opening 21 is in the same vertical plane as that containing the rectangular opening 3 of the advertising panel 1, this opening 21 being closed off by a removable plate 23.

Housed and guided inside the horizontal cross member 20, at each movable member or rotary prism 4, is a mechanical device interacting with modules arranged so as to form a drive device of the wheel and worm type as is described in European patent EP 0539308 or French patent FR 0507973 belonging to the applicant.

FIGS. 2 and 3 illustrate an attachment device 50 making it possible to hold a display strip 5 on the corresponding face 40, 41 and 42 of a movable member or rotary prism 4 of an advertising panel 1.

Each display strip 5 is bonded over its whole height to a shape-memory, semi-rigid, plastic film tape 6 comprising continuous flaps 7 as described and protected in patent EP 1105859 belonging to the applicant.

The attachment device consists of a slat 8 made of a plastic such as PVC having, at rest, that is to say before it is attached to one of the corresponding faces 40, 41 and 42 of the rotary prism 4, a profile in an arc of a circle or domed.

The arc-of-circle profile of the slat 8 is provided with a radius making it possible to determine at its middle a height d representing the distance of elastic deformation of said slat (FIG. 6).

The slat 8 comprises snap-fitting means 11 on its inner convex face 10, that is to say, the face coming into contact with the face 40, 41 and 42 of the rotary prism 4 after elastic deformation.

According to the width of the slat 8, that is to say, the distance L separating the extreme edges 9, the snap-fitting means 11 are provided in the middle of said slat and supported via its main axis XX′. In this case, the central axis XX′ of the slat 8 is indistinguishable from the central axis of each face 40, 41 and 42 of the rotary prism 4.

The snap-fitting means 11 are provided to interact with a groove 12 of matching profile and arranged in the middle and over the whole length of the face 40, 41 and 42 of the rotary prism 4.

Over the whole length of the slat 8, the snap-fitting means 11 consist of two elastic and parallel bars 13, 14 placed one facing the other in order to delimit a longitudinal channel 15.

Each bar 13, 14 comprises, at its free end and on the outside of the channel 15, a shoulder 16 provided with two faces 17, 18 that are inclined in opposite directions so that the angle α provided between the two faces lies between 60 and 105 degrees (FIG. 7).

In the exemplary embodiment according to the present invention, the angle α provided between the two faces 17 and 18 is equal to 90 degrees (FIG. 7).

The base of the first inclined face 17 of the shoulder 16 of each bar 13, 14 is provided, before elastic deformation, to be at a distance h from the inner face 10 of each slat 8 (FIG. 6).

The groove 12 provided on each face 40, 41 and 42 of each rotary prism 4 of the advertising panel 1 comprises, close to its bottom 19 and on each of its parallel and opposite walls 26, 27, a longitudinal rib 28 having a beak-shaped profile and extending in the direction of the center of the groove 12.

Each longitudinal rib 28 comprises a first face 29 that is horizontal and parallel to the bottom 19 of the groove 12 and a second inclined face 30 extending the first on the side of the opening of said groove.

The first horizontal face 29 of the longitudinal rib 28 of each groove 12 is provided to be at a distance e from the outer face 40, 41 and 42 of each rotary prism 4 (FIG. 7).

Note that the distance h separating the base of the shoulder 16 from the inner face 10 of each slat 8, before elastic deformation, is provided with a dimension that is less than e separating the first horizontal face 29 from the outer face 40, 41 and 42 of each rotary prism 4 (FIGS. 6 and 7).

This difference of dimensions between the distances h and e makes it possible, during the attachment of the slat 8, for the latter to be able to deform elastically so that its inner face 10 comes into contact, over its whole width, against the corresponding face 40, 41 and 42 of the rotary prism 4.

Each slat 8 is attached by the interaction of the elastic bars 13, 14 with the groove 12 of the corresponding face 40, 41 and 42 and more particularly when the shoulders 16 of each bar 13, 14 are housed between the bottom 19 of said groove and the ribs 28 of each wall 26, 27.

The elastic deformation of the slat 8 makes it possible to apply, at its extreme edges 9, a pressure making it possible to hold, between said extreme edges and the face 40, 41 and 42 of the rotary prism 4, flaps 7 of the shape-memory, semi-rigid plastic film 6 to which a display strip 5 is bonded.

FIGS. 4 and 5 show a variant of the attachment device 50 when the width of the faces 40, 41 and 42 of the rotary prism 4 is greater than the manufacturing width L provided between the extreme edges 9 of the slat 8.

Therefore, each face 40, 41 and 42 of the rotary prism 4 comprises, on either side and at equal distance from its longitudinal and central axis YY′, two grooves 12 that are similar to those described above.

With respect to the attachment device 50, the latter consists of two symmetrical slats 51 and 52 made of a plastic such as PVC and having, at rest, that is to say before they are attached to each face 40, 41 and 42 of the rotary prism 4, a profile in an arc of a circle or domed.

The arc-of-circle profile of each slat 51, 52 is provided with a radius making it possible to determine, at the snap-fitting means 55, a height d representing the distance of elastic deformation of said slat.

Each slat 51, 52 comprises on its inner convex surface 54, that is to say the surface coming into contact with the face 40, 41 and 42 of the rotary prism 4 after elastic deformation, snap-fitting means 55 similar to those 11, of the slat 8, described above.

Note that the snap-fitting means 55 are offset laterally relative to the central axis ZZ′ of each slat 51, 52. In this case, the central axis ZZ′ of each slat 51, 52 is offset laterally from the central axis YY′ of each face 40, 41 and 42 of the rotary prism 4.

The positioning of the snap-fitting means 55 on each slat 51, 52 makes it possible to determine that one of the extreme edges 53 and more particularly the one interacting with the continuous flap 7 of the display strip 5 is furthest away from said snap-fitting means 55.

The slats 51, 52 are attached to a face 40, 41 and 42 of the rotary prism 4 by the interaction of each snap-fitting means 55 with the corresponding groove 12 and in the same manner as for the snap-fitting means 11 described above.

The attachment of the slats 51, 52 causes an elastic deformation of the latter making it possible to apply, at the extreme edges 53, furthest from the snap-fitting means 55, a pressure making it possible to hold, between said extreme edges 53 and the face 40, 41 and 42 of the rotary prism 4, the continuous flaps 7 of the corresponding display strip 5.

Note that, when the slat 8, 51, 52 is held on the face 40, 41 and 42 of the rotary prism 4, the shoulders 16 of the attachment means 11, 55 do not come into contact with the bottom 19 of the grooves 12 arranged in each face 40, 41 and 42.

It must furthermore be understood that the foregoing description has been given only as an example and that it in no way limits the field of the invention that would not be departed from by replacing the described execution details with any other equivalent.

1. An attachment device for holding an advertising display consisting of display strips (5) comprising continuous flaps (7), each display strip (5) being designed to be attached to the faces (40, 41, 42) of each rotary prism (4) of an advertising panel (1), characterized in that it consists of at least one slat (8; 51, 52) having a profile in an arc of a circle whose inner face (10, 54) is fixedly attached to snap-fitting means (11, 55) while each slat (8; 51, 52) has at its snap-fitting means (11, 55) an elastic deformation height d making it possible to apply to the extreme edges (9, 53) of each slat (8; 51, 52) a pressure force making it possible to hold, between said extreme edges (9, 53) and the face (40, 41 and 42) of the rotary prism (4), the continuous flaps (7) of the corresponding display strip (5).

2. The attachment device as claimed in claim 1, characterized in that the snap-fitting means (11, 55) consist of two elastic and parallel bars (13, 14) placed one facing the other in order to delimit a longitudinal channel (15), each bar (13, 14) comprising at its free end and outside the channel (15) a shoulder (16) provided with two faces (17, 18) that are inclined in opposite directions at an angle α lying between 60 and 105 degrees.

3. The attachment device as claimed in claim 2, characterized in that the angle α a provided between the two faces (17, 18) is equal to 90 degrees.

4. The attachment device as claimed in claim 2, characterized in that the base of the first inclined face (17) of the shoulder (16) of each bar (13, 14) is designed, before elastic deformation, to be at a distance h from the inner face (10, 54) of each slat (S; 51, 52).

5. The attachment device as claimed in claim 1, characterized in that the snap-fitting means (11, 55) interact with a groove (12) arranged in the face (40, 41, 42) of each rotary prism (4) and comprising a bottom (19) and parallel walls (26, 27) each provided, in the direction of the center of the groove (12), with a longitudinal rib (28) having a beak-shaped profile.

6. The attachment device as claimed in claim 5, characterized in that each longitudinal rib (28) comprises a first horizontal face (29) parallel with the bottom (19) of the groove (12) and a second inclined face (30) extending the first (29) on the side of the opening of said groove.

7. The attachment device as claimed in claim 6, characterized in that the first horizontal face (29) of each longitudinal rib (28) is provided to be at a distance e from the outer face (40, 41 and 42) of each rotary prism (4).

8. The attachment device as claimed in claim 7, characterized in that the snap-fitting means (11, 55) consist of two elastic and parallel bars (13, 14) placed one facing the other in order to delimit a longitudinal channel (15), each bar (13, 14) comprising at its free end and outside the channel (15) a shoulder (16) provided with two faces (17, 18) that are inclined in opposite directions at an angle α lying between 60 and 105 degrees; the base of the first inclined face (17) of the shoulder (16) of each bar (13, 14) is designed, before elastic deformation, to be at a distance h from the inner face (10, 54) of each slat (8; 51, 52); and the distance h, before elastic deformation of the slat (S; 51, 52), has a dimension that is less than e.

9. The attachment device as claimed in claim 1, characterized in that the snap-fitting means (11) of the slat (8) are provided in the middle of said slat and supported via its main axis XX′ which is indistinguishable from the central axis of each face (40, 41, 42) of the rotary prism (4).

10. The attachment device as claimed in claim 1, characterized in that the slats (51, 52) are symmetrical.

11. The attachment device as claimed in claim 1, characterized in that the snap-fitting means (55) of each slat (51, 52) are offset laterally relative to the central axis ZZ′.

12. The attachment device as claimed in claim 1, characterized in that the central axis ZZ′ of each slat (51, 52) is offset laterally from the central axis YY′ of each face (40, 41, 42) of the rotary prism (4).

13. The attachment device as claimed in claim 11, characterized in that the extreme edge (53) furthest from the snap-fitting means (55) is designed to interact, after deformation of the slat (51, 52), with the continuous flap (7) of the display strip (5).
